(19) United States
(12) Patent Application Publication
(10) Pub. No.: US 2025/0348528 A1
(43) Pub. Date: Nov. 13, 2025

(54) HASH TAG GENERATION DEVICE, HASH TAG GENERATION METHOD, AND RECORDING MEDIUM

(71) Applicant: NEC Corporation, Tokyo (JP)

(72) Inventors: Takuma SATO, Tokyo (JP); Yoshiyuki ETOU, Tokyo (JP); Fumihiro TANIGUCHI, Tokyo (JP)

(73) Assignee: NEC Corporation, Tokyo (JP)

(21) Appl. No.: 19/169,139

(22) Filed: Apr. 3, 2025

(30) Foreign Application Priority Data
May 10, 2024 (JP) 2024-077276

(51) Int. Cl. G06F 16/383; G06F 16/3329

(52) U.S. Cl. CPC G06F 16/383; G06F 16/33295

(57) ABSTRACT

A hash tag generation device includes a memory storing instructions; and one or more processors configured to execute the instructions to: receive a generation prompt to generate a hash tag for content including at least one of a sentence, an image, a moving image, and a voice; set a plurality of personalities for generating a hash tag for a language model used for generating the hash tag; generate a hash tag of the content through an interaction using a prompt among a plurality of personalities set for the language model; and output the generated hash tag.

This application is based upon and claims the benefit of priority from Japanese Patent Application No. 2024-77276, filed on May 10, 2024, the disclosure of which is incorporated herein in its entirety by reference.

### TECHNICAL FIELD

The present disclosure relates to a hash tag generation device, a hash tag generation method, and a recording medium.

### BACKGROUND ART

In order to reduce the number of processes for generating a hash tag by the content provider, there is a technique for automatically generating a hash tag.

Japanese Patent Application Laid-open Publication No. 2023-145963 discloses technology for generating a hash tag for digital content posted on a social networking service (SNS) service or the like.

### SUMMARY

An object of the present disclosure is to provide a hash tag generation device and the like capable of generating a hash tag with which a user can easily find content.

A hash tag generation device according to an aspect of the present disclosure includes a reception means for receiving a generation prompt to generate a hash tag for content including at least one of a sentence, an image, a moving image, and a voice, a setting means for setting a plurality of personalities for generating a hash tag for a language model used for generating the hash tag, a generation means for generating a hash tag of the content through an interaction using a prompt among a plurality of personalities set for the language model, and an output means for outputting the generated hash tag.

In a hash tag generation method according to an aspect of the present disclosure, the method includes receiving a generation prompt to generate a hash tag for content including at least one of a sentence, an image, a moving image, and a voice, setting a plurality of personalities for generating a hash tag for a language model used for generating the hash tag, generating a hash tag of the content through an interaction using a prompt among a plurality of personalities set for the language model, and outputting the generated hash tag.

A non-transitory recording medium according to an aspect of the present disclosure stores a program for causing a computer to execute receiving a generation prompt to generate a hash tag for content including at least one of a sentence, an image, a moving image, and a voice, setting a plurality of personalities for generating a hash tag for a language model used for generating the hash tag, generating a hash tag of the content through an interaction using a prompt among a plurality of personalities set for the language model, and outputting the generated hash tag.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a hash tag generation device according to the present disclosure;

FIG. 2 is a diagram illustrating a hardware configuration in which the hash tag generation device according to the present disclosure is implemented by a computer device and its peripheral device;

FIG. 3 is a diagram illustrating an example of receiving a generation prompt in the present disclosure;

FIG. 4 is a diagram for describing an example of setting a personality in the present disclosure;

FIG. 5 is a diagram for describing an example of setting a personality in the present disclosure;

FIG. 6 is a diagram for describing an example of generating a hash tag in the present disclosure;

FIG. 7 is a diagram for describing an example of generating a hash tag in the present disclosure;

FIG. 8 is a diagram for describing an example of generating a hash tag in the present disclosure;

FIG. 9 is a flowchart illustrating an outline of an operation of the hash tag generation device according to the present disclosure;

FIG. 10 is a block diagram illustrating a configuration of a hash tag generation device according to the present disclosure.; and

FIG. 11 is a diagram for describing a modification of content in the present disclosure.

### EXAMPLE EMBODIMENT

Hereinafter, example embodiments of a hash tag generation device, a hash tag generation method, a program, and a non-transitory recording medium recording the program according to the present disclosure will be described in detail with reference to the drawings. The present example embodiment does not limit the disclosed technology.

### First Example Embodiment

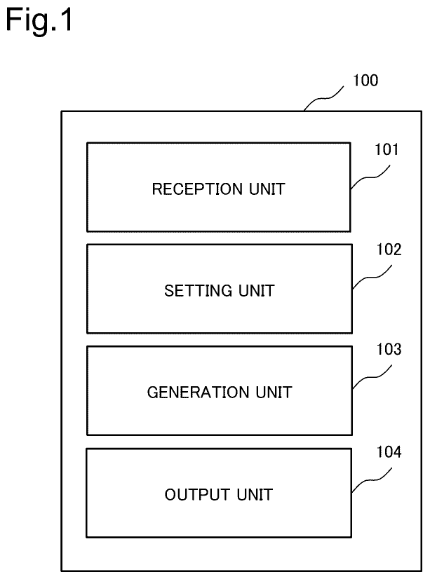

FIG. 1 is a block diagram illustrating a configuration of a hash tag generation device 100 in the present disclosure. As illustrated in FIG. 1, the hash tag generation device 100 includes a reception unit 101, a setting unit 102, a generation unit 103, and an output unit 104. A hash tag generation device 100 of the present disclosure is a device that generates a hash tag for search for content managed in an organization such as a company.

Examples of the content include internal documents transmitted to the inside of the company, messages by e-mail or chat, word-of-mouth information about products, and the like. In the present disclosure, generation of a hash tag will be described using an internal document such as a business trip application manual as an example, but the content is not limited thereto.

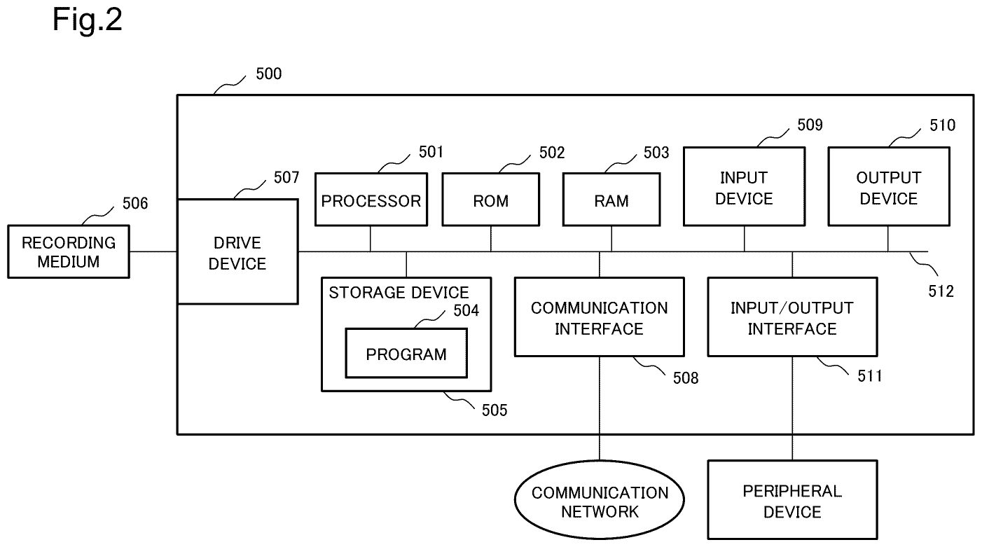

FIG. 2 is a diagram illustrating an example of a hardware configuration in which the hash tag generation device 100 in the present disclosure is achieved by a computer device 500 including a processor. As illustrated in FIG. 1, the hash tag generation device 100 includes a processor 501, a memory such as a read only memory (ROM) 502 and a random access memory (RAM) 503, a storage device 505 such as a hard disk that stores a program 504, a communication interface (I/F) 508 for network connection, and an input/output interface 511 that inputs and outputs data.

The processor 501 controls the entire computer device 500. As the processor 501, for example, a central processing unit (CPU), a digital signal processor (DSP), a graphics processing unit (GPU), a micro processing unit (MPU), a floating point number processing unit (FPU), a physics processing unit (PPU), a tensor processing unit (TPU), a quantum processor, a combination thereof, or the like can be used.

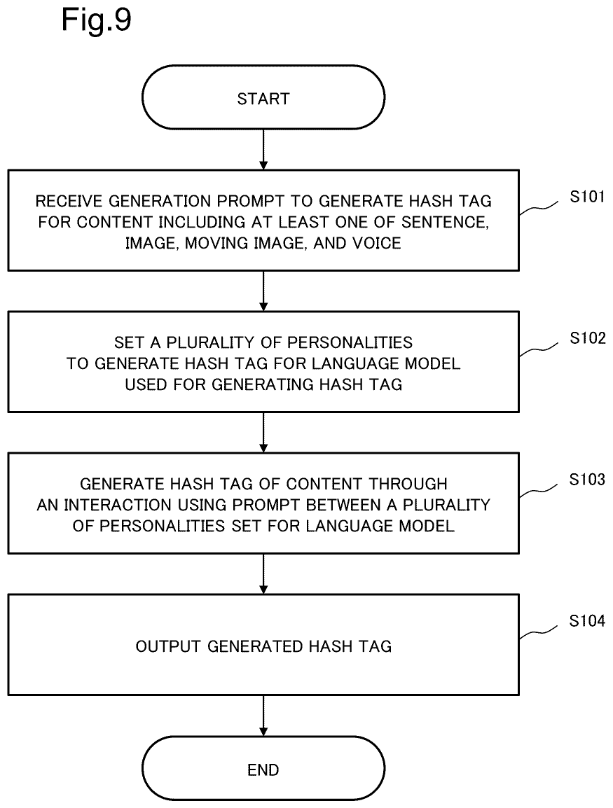

The processor 501 operates the operating system to control the entire hash tag generation device 100 according to the present disclosure. The processor 501 reads a program and data from the recording medium 506 attached to a drive device 507 or the like to a memory, for example. The processor 501 functions as the reception unit 101, the setting unit 102, the generation unit 103, the output unit 104, and part thereof in the present disclosure, and executes processing or a command in the flowchart illustrated in FIG. 9 to be described later based on a program.

The recording medium 506 is, for example, an optical disk, a flexible disk, a magnetic optical disk, an external hard disk, a semiconductor memory, or the like. The recording medium as part of the storage device is a nonvolatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check an output.

As described above, the hash tag generation device 100 illustrated in FIG. 1 is achieved by the computer hardware illustrated in FIG. 2. However, the means for 10 achieving each unit included in the hash tag generation device 100 in FIG. 1 is not limited to the above-described configuration. In addition, the hash tag generation device 100 may be achieved by one physically coupled device, or may be achieved by a plurality of devices in which two or more physically separated devices are connected in a wired or wireless manner. For example, the input device 509 and the output device 510 may be 15 connected to the computer device 500 via a network. The hash tag generation device 100 illustrated in FIG. 1 can also be configured by cloud computing or the like.

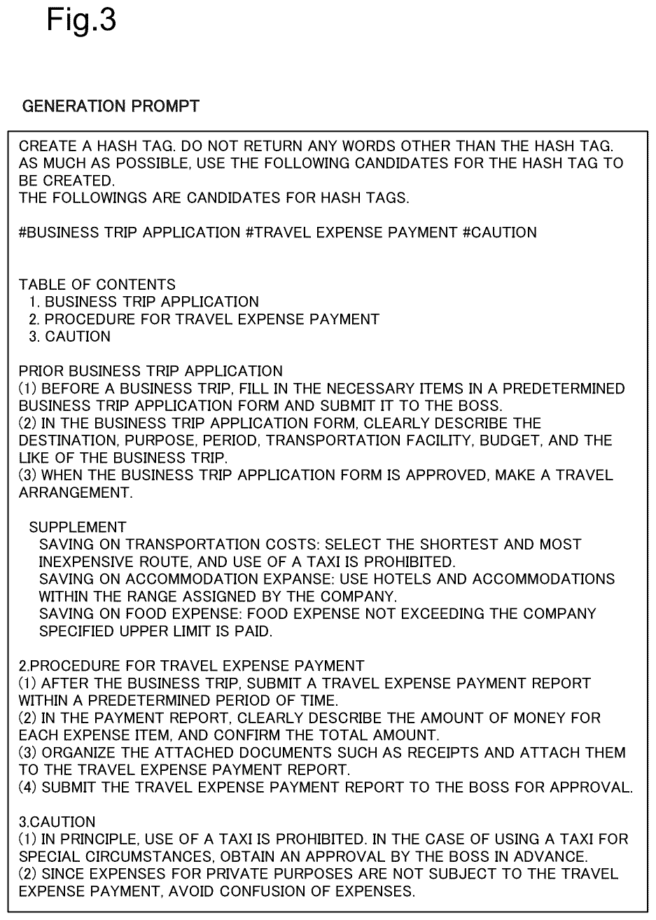

The reception unit 101 is a means for receiving a generation prompt to generate a hash tag for content including at least one of a sentence, an image, a moving image, and a voice. For example, the reception unit 101 receives the file of the content whose hash tag is to be created from the server device in which the content is stored through the application program for content browsing. When the content is a sentence, the reception unit 101 may receive the content on a text basis. For content for which a hash tag has been generated in the past, the reception unit 101 may receive the hash tag as a hash tag candidate. FIG. 3 is a diagram illustrating an example of receiving a generation prompt in 25 the present disclosure. As illustrated in FIG. 3, the generation prompt includes details of the content and an instruction to generate a hash tag for the content.

The setting unit 102 is a means for setting a plurality of personalities for generating the hash tag for the language model used for generating the hash tag. The personality is an individual characteristic, for example, an occupation or a role. The role may include content to be output for the input information, desired behavior, and the like.

The setting unit 102 at least includes, as a plurality of personalities, for example, an interviewer that asks a question for which the details of the content are an answer, a copy writer that generates a hash tag, and a facilitator that supports an interaction between the copy writer and the interviewer. Giving the language model a personality of the professional profession increases the possibility of drawing out the abilities of each professional. By the interviewer asking a question in such a way that the details of the content are an answer, it is possible to generate a hash tag that is not directly expressed in the content and is likely to be used as a search tag by a searcher.

As the language model, a known machine learning engine or a natural language processing algorithm can be appropriately used. Further, a language model may include a large language model (LLM), or a transfer model obtained by transfer learning the large language model. Examples of the large language model can include generative pre-training-2 (GPT-2), GPT-3, or GPT-4. Examples of the large language model may include text-to-text transfer transformer (T5), bidirectional encoder representations from transformers (BERT), robustly optimized BERT approach (RoBERTa), and efficiently learning an encoder that classifies token replacements accurately (ELECTRA). The language model may be stored in the storage device 505 or may be a model configured in an external system.

The setting unit 102 may input, to the language model, constraint conditions such as rules to be followed together with the personality. After setting the personality, the setting unit 102 may set a constraint condition when generating a hash tag through an interaction between a plurality of personalities. In this case, the constraint condition is stored in, for example, the storage device 505 or the like, and is set by appropriately referring to the constraint condition during the interaction.

The setting unit 102 may further set a judge for determining validity of the generated hash tag as the plurality of personalities. The validity of the hash tag is, for example, whether the generated hash tag deviates from the details of the content. More specifically, the judge is given the role of, for example, comparing the details of the content with the generated hash tag and deleting content not included in the content or false information. For example, the setting unit 102 may perform setting in such a way that a judge determines validity every time a copy writer generates a hash tag.

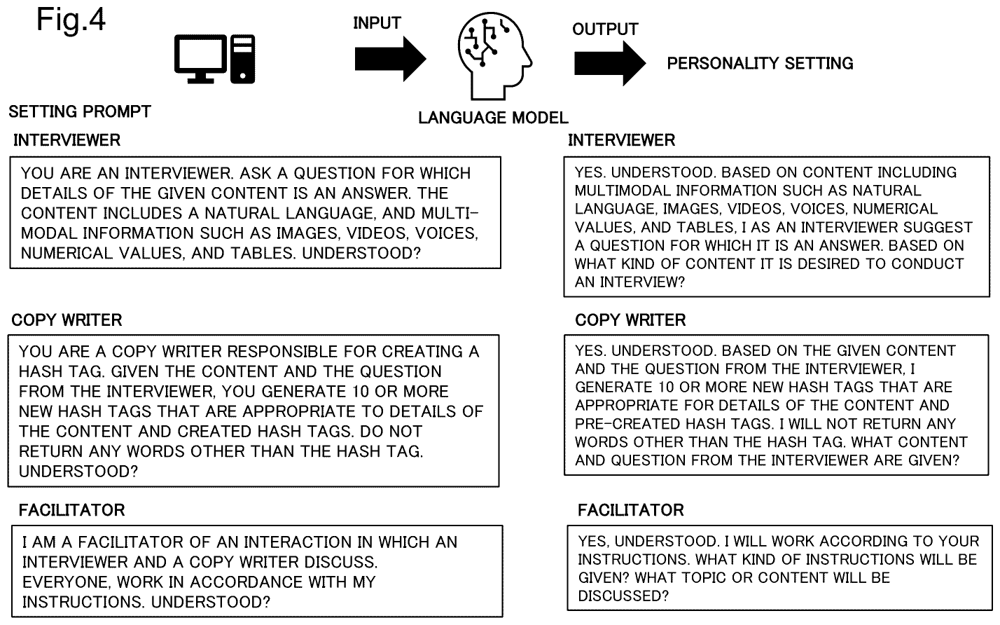

Here, a procedure for setting a personality in a language model will be described with reference to FIG. 4. FIG. 4 is a diagram for describing the setting of the personality of the language model in the present disclosure. As illustrated in FIG. 4, the setting unit 102 sets the personality by inputting a setting prompt for setting the personality to the language model. The setting prompt may include confirmation of a personality to be set, a role to be set, and a statement of not to be output until there is an instruction. The role includes a content to be output for the input information.

In the example of FIG. 4, the setting prompts include content of a role of each personality in addition to giving a plurality of personalities of an interviewer, a copy writer, and a facilitator, respectively. For example, in the interviewer setting prompt, “You are an interviewer. Ask a question for which details of the given content is an answer.” corresponds to the role assigned to the interviewer. In the setting prompt of FIG. 4, the interviewer asks a question “Based on what kind of content it is desired to conduct an interview?”. In this case, the setting unit 102 may answer the question based on the generation prompt received by the reception unit 101.

In the example of FIG. 4, after the personality setting, “Understood?” is input in order to make the language model stop the output, such as “Understood.”. When there is no prompt to stop the output of the language model such as “Understood”, the output of the language model cannot be controlled, and there is a possibility that details different from the content instructed by the generation prompt start to be output before the instruction to create the hash tag.

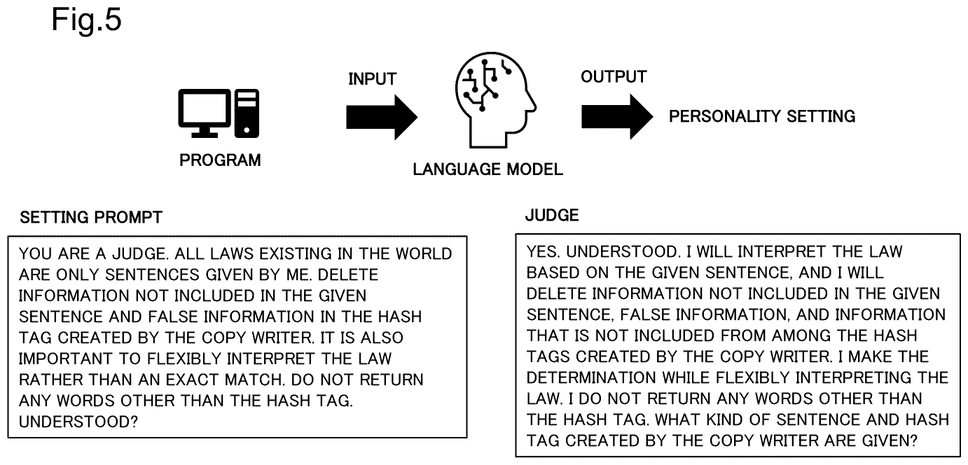

FIG. 5 is an example of a setting prompt when a role of a judge is given. In the example of FIG. 5, the setting prompt of the judge includes the role of the judge in addition to giving the personality of the judge. The setup prompts in FIG. 5 include a method for the judge to determine validity, such as “All laws existing in the world are only documents given by me.” and “It is important to flexibly interpret the law rather than an exact match.”. In the example of FIG. 5, the judge asks a question for getting out information to input “What kind of sentence and hash tag generated by the copy writer are given?”. In this case, the setting unit 102 may answer the question using the content and the hash tag created by the copy writer to the language model.

The generation unit 103 is a means for generating a hash tag of content through an interaction using a prompt among a plurality of personalities set for the language model. More specifically, the generation unit 103 inputs, from the facilitator to the language model, a prompt for instructing the interviewer to ask a question about the details of the content and instructing the copy writer to create the hash tag. The generation unit 103 may input a prompt prepared in advance to the language model by program control. The prompt may also include specifying an output format.

The following describes interaction using prompts among a plurality of personalities. The generation unit 103 may repeatedly execute output of a question for which the content described later is an answer, generation of a hash tag, and determination of validity of the hash tag by program control.

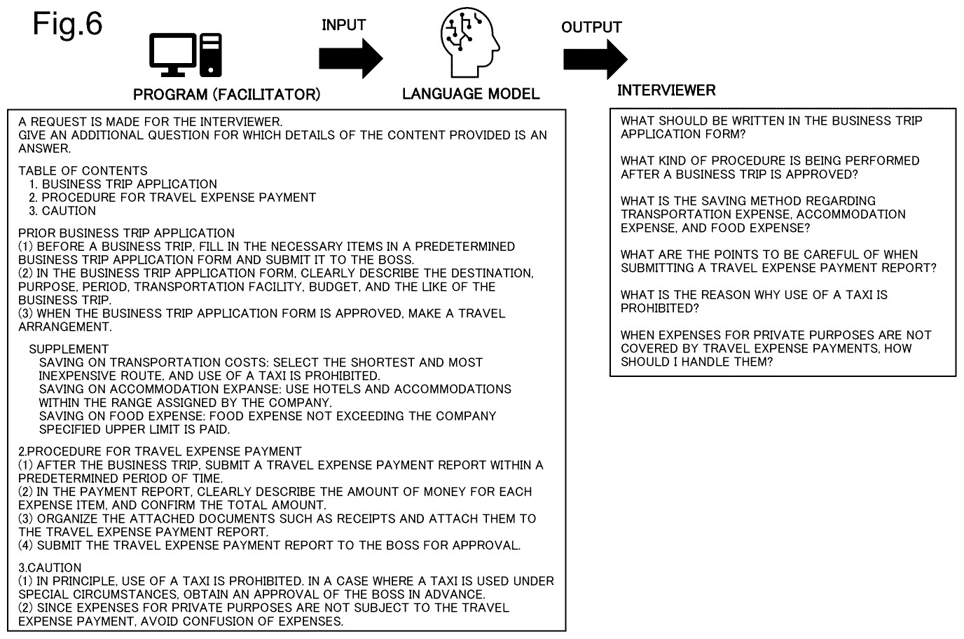

First, the generation unit 103 inputs, to the language model, a prompt for causing the interviewer to output a question for which the content is an answer. A specific example of the prompt will be described with reference to FIG. 6. FIG. 6 is a diagram for describing an example of generating a hash tag in the present disclosure. As illustrated in

FIG. 6, the generation unit 103 inputs, to the language model, a prompt including the details of the content for which the hash tag is to be generated and an instruction for the interviewer to ask a question for which the details of the content are an answer, and the interviewer outputs the question. In the example of FIG. 6, a question for which the details of the content are an answer, such as “What should be written in the business trip application form?” is output.

Next, the generation unit 103 inputs, to the language model, a prompt for causing the copy writer to generate the hash tag based on the details of the content and the question from the interviewer. The generation unit 103 generates a hash tag from the details of the content and the question using various known methods. When receiving the hash tag candidate, the generation unit 103 may generate the hash tag of the content using the hash tag candidate.

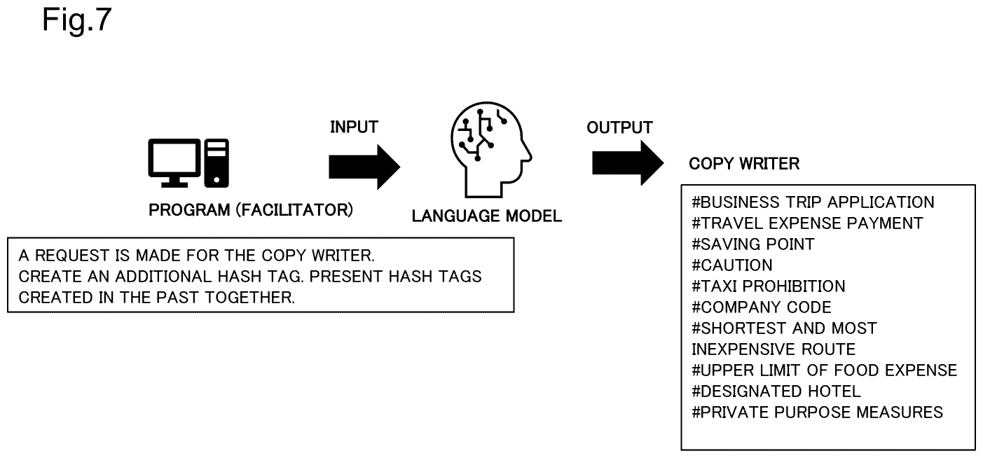

For example, the generation unit 103 extracts a word or a phrase included in the details of the content and the question, and adds “#” to the beginning of the extracted word or phrase to create a search hash tag. The generation unit 103 may generate a hash tag from details of the content and a question using a language model such as LLM. FIG. 7 is a diagram for describing an example of generating a hash tag in the present disclosure. In the example of FIG. 7, the generation unit 103 inputs, to the language model, a prompt of an instruction by the facilitator for the copy writer to create a hash tag and to output the hash tag created in the past together.

When a plurality of personalities further includes a judge to determine the validity of the generated hash tag, the facilitator assists in the interaction between the interviewer, the copy writer, and the judge. Specifically, the generation unit 103 inputs, to the language model, a prompt for causing the judge to delete an invalid hash tag among the hash tags generated by the copy writer. In this case, when the variation of the hash tag is increased, the hash tag deviating from the details of the content can be excluded. However, in the present disclosure, the personality of the judge may not be set.

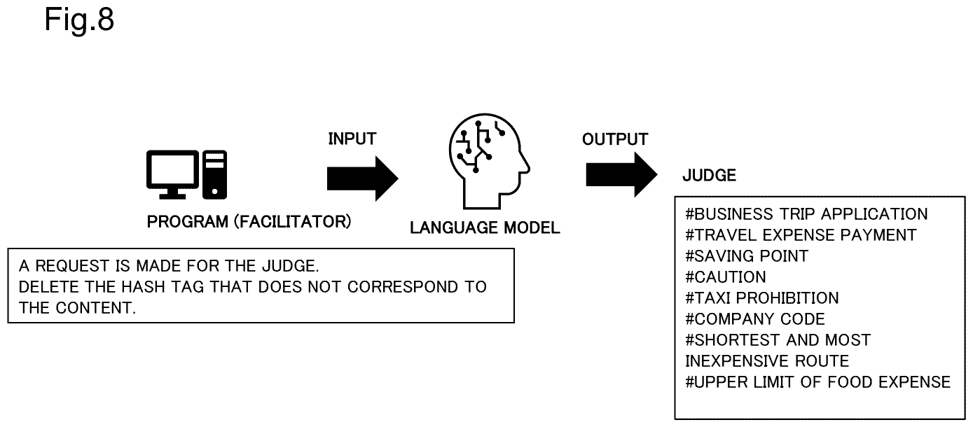

FIG. 8 is a diagram for describing an example of generating a hash tag in the present disclosure. In the example of FIG. 8, the generation unit 103 is a means for causing the facilitator to make a request of the judge for deleting a hash tag that does not correspond to the details of the content.

The output unit 104 is a means for causing a display device such as a display to output the generated hash tag. The output unit 104 displays the generated hash tag together with the details of the content, for example. In a case where the hash tag is generated for the same content a plurality of times, the output unit 104 may display all the hash tags generated in the past.

The operation of the hash tag generation device 100 configured as described above will be described with reference to the flowchart of FIG. 9.

FIG. 9 is a flowchart illustrating an outline of an operation of the hash tag generation device 100 in the present disclosure. The processing according to this flowchart may be executed based on program control by the processor described above.

As illustrated in FIG. 9, first, the reception unit 101 receives a generation prompt to generate a hash tag for content including at least one of a sentence, an image, a moving image, and a voice (step S101). Next, the setting unit 102 sets a plurality of personalities for generating the hash tag for the language model used for generating the hash tag (step S102). Next, the generation unit 103 generates a hash tag of the content through an interaction using a prompt among a plurality of personalities set for the language model (step S103). Finally, the output unit 104 outputs the generated hash tag (step S104).

In the hash tag generation device 100, the setting unit 102 sets a plurality of personalities for generating a hash tag for a language model used for generating the hash tag. The generation unit 103 generates a hash tag of the content through an interaction using a prompt among a plurality of personalities set for the language model. As a result, for example, it is possible to generate a hash tag including information that is output through an interaction and is not directly expressed in content. As a result, it is possible to generate a hash tag with which the user can easily find the content.

### Second Example Embodiment

Next, the second example embodiment of the present disclosure will be described in detail with reference to the drawings. Hereinafter, description of content overlapping with the above description will be omitted to the extent that the description of the present example embodiment is not unclear. As in the computer device illustrated in FIG. 2, each component in each example embodiment of the present disclosure can be achieved not only by hardware but also by a computer device or software based on program control.

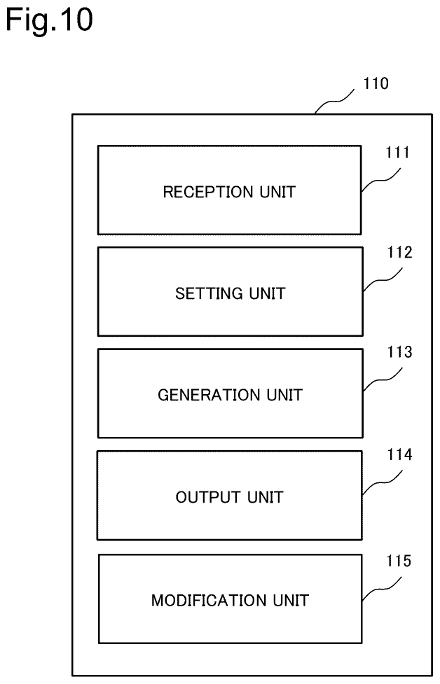

FIG. 10 is a block diagram illustrating a configuration of a hash tag generation device 110 according to the present disclosure. With reference to FIG. 10, the hash tag generation device 100 will be described mainly with respect to a part different from the hash tag generation device 110. The hash tag generation device 110 includes a reception unit 111, a setting unit 112, a generation unit 113, an output unit 114, and a modification unit 115. The components in the present example embodiment are basically similar to the related components in the first example embodiment except that the reception unit 111 and the modification unit 115.

In addition to the function of the reception unit 101, the reception unit 111 receives a search tag input by the user who has searched for the content. The reception unit 111 receives, for example, a search tag input by the user to search for content with respect to an application program for browsing content. The search tag may be a keyword or a text. The reception unit 111 outputs the received search tag to the modification unit 115.

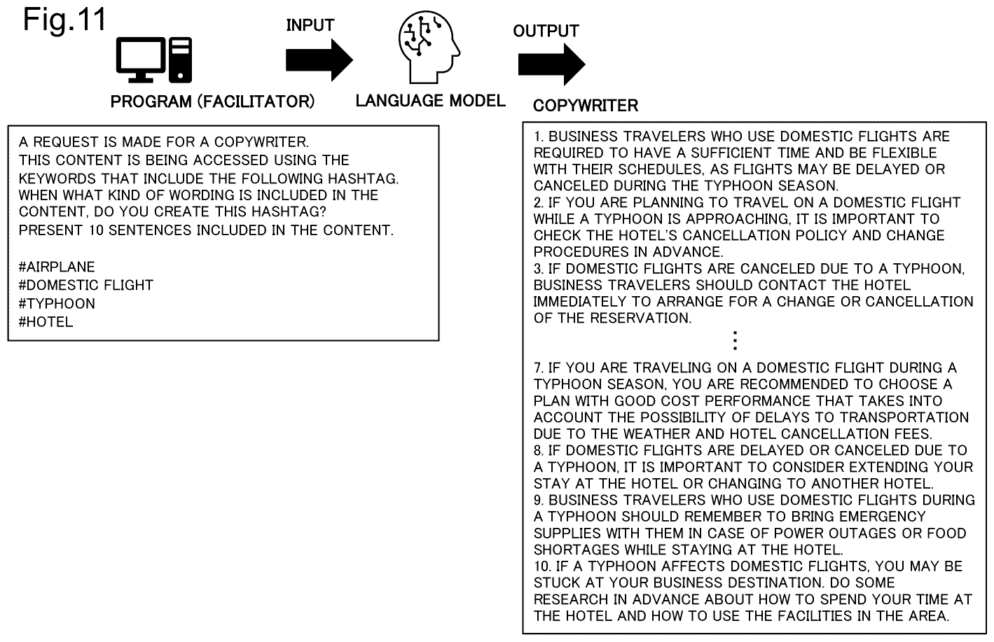

The modification unit 115 is a means for suggesting the modification of the details of the content based on the search tag. For example, the modification unit 115 suggests a modification for reflecting the details related to the search tag in the content. FIG. 11 is a diagram for describing a modification example of content in the present disclosure. As illustrated in FIG. 11, the modification unit 115 inputs, to the language model, a search tag and a prompt for instructing the copy writer to output details of the content in a case where the search tag is generated as a hash tag. In the example of FIG. 11, the prompt includes presenting 10 sentences included in the content.

When receiving the acceptance of the suggested modification, the modification unit 115 may modify the content according to the suggestion. In this case, for example, the output unit 114 display a screen for receiving whether the content administrator or the like accepts the suggested modification. The reception unit 111 receives an answer as to whether to accept the modification based on the information input via the screen. In the example of FIG. 11, the reception unit 111 may receive selection of a sentence to be included in the content among the presented 10 sentences. The modification unit 115 modifies the content based on the received answer. In the example of FIG. 11, the modification unit 115 modifies the content to include the selected sentence, for example.

In the hash tag generation device 110, the modification unit 115 suggests modification of the details of the content based on the search tag. As a result, the content is modified to the content reflecting the details of the search tag used for search, and the content desired to be searched for can be more easily found.

While the present invention is described with reference to example embodiments thereof, the present invention is not limited to these example embodiments. Various modifications that can be understood by those of ordinary skill in the art in the art can be made to the configuration and details of the present invention within the scope of the present invention.

For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content. As the content of the present disclosure, an internal document related to a business trip application is described as an example, but the content of the present disclosure is not limited to the internal document. The content may be content managed in an organization. For example, the invention of the present disclosure is also applicable to electronic medical record information such as nursing records in the medical field, care records in the care field, childcare records in the childcare field, industrial machine or software manuals, design documents, and failure information documents. The content is not limited to the content managed in the organization, and may be, for example, content on the Web.

A nursing record is created at a nursing site in order to plan, implement, and evaluate the nursing care plan, or to make a medical worker's decision. The format of the nursing record includes a subject object assessment plan (SOAP) format, a focus charting format, and a time recording format, all of which are formats including a natural language. At the time of nursing care plan evaluation or medical litigation, nurses need to search for supporting documents from the vast number of nursing records. With the hash tag generation device of the present disclosure, it is possible to generate a hash tag that is easy to search.

In an organization, a large amount of natural language based information such as documents, messages by e-mail or chat, and word-of-mouth information of products is accumulated. A user who searches for information searches for information by inputting a search word in order to search for necessary information. In the search system, the content provider assigns a hash tag in advance in such a way that the user can easily find the corresponding content.

There is a demand for generating a hash tag that makes it easier for a user to find content that the user is looking for. In this case, it is necessary to generate a hash tag including details that are not directly expressed in a text or an image in the content.

An example of an effect of the present disclosure is that it is possible to generate a hash tag that allows a user to easily find content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Various modifications that can be understood by those of ordinary skill in the art can be made to the configuration and details of the present disclosure within the scope of the present invention.

Although the plurality of operations is described in order in the form of a flowchart, the order of description does not limit the order of executing the plurality of operations. Therefore, when each example embodiment is implemented, the order of the plurality of operations may be changed within a range that does not interfere with the content.

Further, it is noted that the inventor's intent is to retain all equivalents of the claimed invention even if the claims are amended during prosecution.

### Supplementary Note

### (Supplementary Note 1)

A hash tag generation device including
a reception means for receiving a generation prompt to generate a hash tag for content including at least one of a sentence, an image, a moving image, and a voice,
a setting means for setting a plurality of personalities for generating a hash tag for a language model used for generating the hash tag,
a generation means for generating a hash tag of the content through an interaction using a prompt among a plurality of personalities set for the language model, and
an output means for outputting the generated hash tag.

### (Supplementary Note 2)

The hash tag generation device according to Supplementary Note 1, wherein the plurality of personalities includes at least an interviewer that asks a question for which details of the content are an answer, a copy writer that generates a hash tag, and a facilitator that supports an interaction between the copy writer and the interviewer.

### (Supplementary Note 3)

The hash tag generation device according to Supplementary Note 2, wherein the generation means generate a hash tag of the content by the facilitator inputting, to the language model, a prompt for causing the interviewer to output a question for which the content is an answer.

### (Supplementary Note 4)

The hash tag generation device according to Supplementary Note 3, wherein the generation means causes the facilitator to input, to the language model, a prompt for causing the copy writer to generate a hash tag based on details of the content and the question from the interviewer.

### (Supplementary Note 5)

The hash tag generation device according to Supplementary Note 2, wherein
the plurality of personalities further includes a judge that determines validity of a generated hash tag, and
the facilitator supports an interaction between the interviewer, the copy writer, and the judge.

### (Supplementary Note 6)

The hash tag generation device according to any one of Supplementary Notes 1 to 5, wherein
the reception means further receives a hash tag candidate for generating a hash tag, and
the generation means generates a hash tag of the content by using the hash tag candidate.

### (Supplementary Note 7)

The hash tag generation device according to Supplementary Note 1, wherein
the reception means further receives a search tag input by a user who has searched for the content, and
the hash tag generation device further includes a modification means for suggesting a modification of the content based on the search tag.

### (Supplementary Note 8)

The hash tag generation device according to Supplementary Note 7, wherein in a case where an acceptance of the suggested modification is received, the modification means further modifies the content in accordance with the suggestion.

### (Supplementary Note 9)

A hash tag generation method by a computer, the hash tag generation method including
receiving a generation prompt to generate a hash tag for content including at least one of a sentence, an image, a moving image, and a voice,
setting a plurality of personalities for generating a hash tag for a language model used for generating the hash tag,
generating a hash tag of the content through an interaction using a prompt among a plurality of personalities set for the language model, and
outputting the generated hash tag.

### (Supplementary Note 10)

A program for causing a computer to execute
receiving a generation prompt to generate a hash tag for content including at least one of a sentence, an image, a moving image, and a voice,
setting a plurality of personalities for generating a hash tag for a language model used for generating the hash tag,
generating a hash tag of the content through an interaction using a prompt among a plurality of personalities set for the language model, and
outputting the generated hash tag.

Some or all of the configurations described in Supplementary Notes 2 to 8dependent on the above-described Supplementary Note 1 can also be dependent on Supplementary Notes 9 and 10 by the dependency relationship similar to that of Supplementary Notes 2 to 8. Furthermore, some or all of the configurations described as the Supplementary Notes can be similarly dependent on not only the Supplementary Notes 1, 9, and 10, but also various pieces of hardware and software, and various recording devices or systems for recording software without departing from the above-described example embodiments.

1. A hash tag generation device comprising:
a memory storing instructions; and
one or more processors configured to execute the instructions to:
receive a generation prompt to generate a hash tag for content including at least one of a sentence, an image, a moving image, and a voice;
set a plurality of personalities for generating a hash tag for a language model used for generating the hash tag;
generate a hash tag of the content through an interaction using a prompt among a plurality of personalities set for the language model; and
output the generated hash tag.

2. The hash tag generation device according to claim 1, wherein
the plurality of personalities includes at least an interviewer that asks a question for which details of the content are an answer, a copy writer that generates a hash tag, and a facilitator that supports an interaction between the copy writer and the interviewer.

3. The hash tag generation device according to claim 2, wherein
the one or more processors are further configured to execute the instructions to:
generate a hash tag of the content by the facilitator inputting, to the language model, a prompt for causing the interviewer to output a question for which the content is an answer.

4. The hash tag generation device according to claim 3, wherein
the one or more processors are further configured to execute the instructions to:
generate a hash tag of the content by the facilitator inputting, to the language model, a prompt for causing the copy writer to generate a hash tag based on details of the content and the question from the interviewer.

5. The hash tag generation device according to claim 2, wherein
the plurality of personalities further includes a judge that determines validity of a generated hash tag, and the facilitator supports an interaction between the interviewer, the copy writer, and the judge.

6. The hash tag generation device according to claim 1, wherein
the one or more processors are further configured to execute the instructions to:
further receive a hash tag candidate for generating a hash tag, and
generate a hash tag of the content using the hash tag candidate.

7. The hash tag generation device according to claim 1, wherein
the one or more processors are further configured to execute the instructions to:
further receive a search tag input by a user who has searched for the content, and
suggest a modification of details of the content based on the search tag.

8. The hash tag generation device according to claim 7, wherein
the one or more processors are further configured to execute the instructions to:
in a case where an acceptance of the suggested modification is received, further modifies the content in accordance with the suggestion.

9. A hash tag generation method by a computer, the hash tag generation method comprising:
receiving a generation prompt to generate a hash tag for content including at least one of a sentence, an image, a moving image, and a voice;
setting a plurality of personalities for generating a hash tag for a language model used for generating the hash tag;
generating a hash tag of the content through an interaction using a prompt among a plurality of personalities set for the language model; and
outputting the generated hash tag.

10. A non-transitory computer-readable recording medium that records a program for causing a computer to execute:
receiving a generation prompt to generate a hash tag for content including at least one of a sentence, an image, a moving image, and a voice;
setting a plurality of personalities for generating a hash tag for a language model used for generating the hash tag;
generating a hash tag of the content through an interaction using a prompt among a plurality of personalities set for the language model; and
outputting the generated hash tag.
